(19) United States
(12) Patent Application Publication
(10) Pub. No.: US 2026/0299181 A1
(43) Pub. Date: Oct. 1, 2026

(54) POLARIZED LIGHT CONVERSION DEVICE AND MANUFACTURING METHOD THEREFOR

(71) Applicant: FOCTEK PHOTONICS INC., Fuzhou (CN)

(72) Inventors: Yuanqiang ZHU, Fuzhou (CN); Jianling DING, Fuzhou (CN); Manna TIAN, Fuzhou (CN); Jianlong ZHU, Fuzhou (CN); Xiaojing CHEN, Fuzhou (CN); Xiao LIANG, Fuzhou (CN)

(21) Appl. No.: 19/569,461

(22) Filed: Mar. 17, 2026

(30) Foreign Application Priority Data
Mar. 27, 2025 (CN) 202510371682.5

(51) Int. Cl. G02B 5/30; G02B 27/28

(52) U.S. Cl. CPC G02B 5/3016; G02B 27/285

(57) ABSTRACT

Provided in the embodiments of the present disclosure is a polarized light conversion device, including a polarizing beam splitter array and a patterned polymer half-wave plate, the patterned polymer half-wave plate being disposed on an optical output path of the polarizing beam splitter array. Also provided in the embodiments of the present disclosure is a manufacturing method for a polarized light conversion device, which utilizes a PBS flat plate optical path to directly fabricate a patterned half-wave plate in a required region on the liquid crystal polymer layer, replacing the traditional wave plate bonding process, and reducing the fabrication difficulty. The present disclosure can be applied to precision miniaturization scenarios, achieving the miniaturization of optical systems.

### CROSS-REFERENCE TO RELATED APPLICATIONS

This application claims priority to Chinese Patent Application 202510371682.5, filed on Mar. 27, 2025, which is incorporated herein by reference.

### TECHNICAL FIELD

The present disclosure belongs to the technical field of fabrication and manufacturing for optical devices, and particularly relates to a polarized light conversion device and a manufacturing method therefor.

### BACKGROUND

Traditional illumination sources in polarized projection display systems are all non-polarized light sources, thus polarizing devices are required for use. Commonly used polarizing devices include a polarizing beam splitter (PBS) and a polarization conversion system (PCS): the PBS is formed by cementing together a pair of isosceles right-angle prisms, wherein an inclined surface of one of the prisms is coated with a polarizing beam splitter film, and converting non-polarized light into polarized light will result in a loss of at least 50% of the energy.

The PCS is formed by cementing multiple PBSs together, and converting p-polarized light into s-polarized light or converting s-polarized light into p-polarized light can maintain over 80% of the energy of the original unpolarized light, which significantly contributes to the light utilization efficiency, contrast ratio, and image color saturation of projection systems.

However, traditional PCS fabrication requires positioning and bonding half-wave plate long strips strip by strip into a PBS array, which is difficult in operation, time-consuming, inefficient, and costly, which is unfavorable for widespread application.

### SUMMARY

Based on this, regarding the problem of how to reduce the difficulty of fabrication operations and improve fabrication efficiency, there is a need to provide a polarized light conversion device and a manufacturing method therefor that can reduce the difficulty of fabrication operations and improve fabrication efficiency.

Provided in the embodiments of the present disclosure is a polarized light conversion device, comprising a polarizing beam splitter array and a half-wave plate;
the polarizing beam splitter array is formed by bonding several first light-transmitting components; second light-transmitting components are bonded to both ends of the polarizing beam splitter array, and a polarizing beam splitter film is disposed between each first light-transmitting component and a first light-transmitting component or second light-transmitting component adjacent thereto; the half-wave plate is disposed on an optical output path of the polarizing beam splitter array.

The half-wave plate is a patterned polymer layer made of a liquid crystal polymer;
the patterned polymer layer is formed by achieving directional alignment of liquid crystal molecules in a polymer layer through a photochemical reaction using S-polarized light emitted from the polarizing beam splitter array, enabling a liquid crystal polymer layer to be directly patterned to serve as the half-wave plate.

Also provided in the embodiments of the present disclosure is a polarized light conversion device, comprising:
a polarizing beam splitter array, formed by bonding several first light-transmitting components, second light-transmitting components being bonded to both ends of the polarizing beam splitter array, and a polarizing beam splitter film being disposed between each first light-transmitting component and a first light-transmitting component or second light-transmitting component adjacent thereto; and
a half-wave plate, disposed on an optical output path of the polarizing beam splitter array,
wherein the half-wave plate is a polymer layer formed by coating a liquid crystal polymer on an optical output path of the polarizing beam splitter array and patterning the liquid crystal polymer by directly using S-polarized light emitted from the polarizing beam splitter array during manufacturing.

Also provided in the embodiments of the present disclosure is a manufacturing method for a polarized light conversion device, comprising the following steps:
step S1, polarizing beam splitter (PBS) fabrication: selecting quartz glass as a substrate material for a prism, and fabricating same into a right-angle prism and a rhombic prism;
step S2, PBS film coating: coating an inclined surface of the rhombic prism with a polarizing beam splitter film;
step S3, PBS flat plate fabrication: bonding together inclined surfaces of two adjacent rhombic prisms through optical contacting; bonding together several rhombic prisms into a whole through optical contacting, to form a polarizing beam splitter array; and bonding right-angle prisms to both ends of the polarizing beam splitter array through optical contacting, to form a PBS flat plate structure;
step S4, polymer coating and curing: coating an optical output path of a PBS flat plate with a liquid crystal polymer to form a polymer layer, and drying and curing the polymer layer by heating;
step S5, photo-alignment: modulating an ultraviolet light source into S-polarized light with a pattern identical to a pattern of a patterned polymer half-wave plate, irradiating the S-polarized light to an optical input path of the polarizing beam splitter array, and achieving directional alignment of liquid crystal molecules in the polymer layer using a photochemical reaction, thus forming the patterned polymer half-wave plate; and
step S6, post-processing: subjecting a photo-aligned polarized light conversion device to a baking treatment, and subjecting a baked polarized light conversion device to optical performance testing and appearance inspection.

### BRIEF DESCRIPTION OF DRAWINGS

To more clearly illustrate the technical solutions in the embodiments of the present disclosure, the drawings used in the description of the embodiments will be briefly introduced below. It is apparent that the drawings described below are only some embodiments of the present disclosure. For those of ordinary skill in the art, other drawings can be obtained based on these drawings without creative effort.

FIG. 1 is a schematic overall structural diagram of a polarization conversion system (PCS) of the present disclosure;

FIG. 2 is a schematic diagram of an optical path of photo-alignment of a polarization conversion system of the present disclosure;

FIG. 3 is a flowchart of steps of a manufacturing method for a polarization conversion system of the present disclosure.

### DESCRIPTION OF EMBODIMENTS

The technical solutions in the embodiments of the present disclosure will be clearly and intactly described below in conjunction with the drawings in the embodiments of the present disclosure. It is apparent that the embodiments described are only some embodiments of the present disclosure, and not all embodiments. Based on the embodiments of the present disclosure, all other embodiments obtained by those of ordinary skill in the art without creative work fall within the protection scope of the present disclosure.

Provided in this embodiment is a polarized light conversion device, including a polarizing beam splitter array and a half-wave plate.

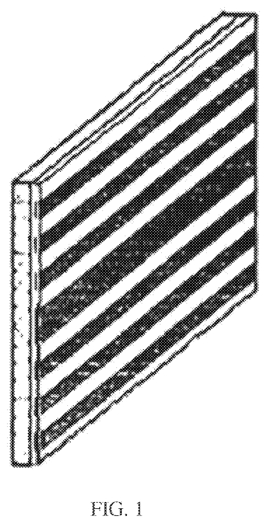

Referring to FIG. 1, the polarizing beam splitter array is formed by bonding several first light-transmitting components; second light-transmitting components are bonded to both ends of the polarizing beam splitter array, and a polarizing beam splitter film is disposed between each first light-transmitting component and a first light-transmitting component or second light-transmitting component adjacent thereto; the half-wave plate is disposed on an optical output path of the polarizing beam splitter array.

The half-wave plate is a patterned polymer layer made of a liquid crystal polymer.

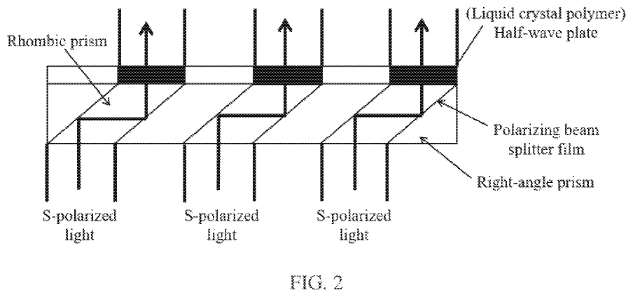

It needs to be noted that in the fields of materials science and micro and nano-fabrication, patterning refers to the process of forming microscopic or macroscopic structures with specific geometric shapes, sizes, arrangements, or functional distributions on the surface of a material or inside the material through specific technological methods. The patterned polymer layer refers to that through patterning techniques, ordered or customized micro and nano-structures are constructed on a polymer substrate or film, thereby imparting them with special optical, electrical, mechanical, or biological functions. Referring to FIG. 2, the patterned polymer layer is of a structure consisting of two parts: one part (shown in black) that can achieve light polarization, and another alternating part (shown in white) that cannot achieve the light polarization function.

Referring to FIG. 1, the polarizing beam splitter array includes two right-angle prisms and several rhombic prisms; several rhombic prisms are arranged between the two right-angle prisms, and each prism connection is coated with a polarizing beam splitter film; each rhombic prism and a rhombic prism or right-angle prism adjacent thereto are bonded together into a whole through optical contacting.

A quartz glass material capable of transmitting both far-ultraviolet light and visible and near-infrared light is selected as a substrate material for the prism; the specifications of the polarizing beam splitter film (PBS film) are as follows: Tp>99%@420-680 nm; Rs>99%@350-680 nm; AOI=45 degrees (incident on glass).

In this embodiment, the right-angle prism has a specification of 2*2 mm, and the specifications of the rhombic prism are a width of 2 mm and an inclination angle of 45 degrees, such that the rhombic prism and the right-angle prism can be bonded together through optical contacting, thus forming a PBS flat plate structure. The first light-transmitting component and the second light-transmitting component can also be bonded together through other bonding materials to form a PBS flat plate structure. Provided that such materials do not cause absorption loss of the photo-alignment ultraviolet light and maintain the connection relationship unchanged, they can achieve the same effect and are therefore all applicable, and will not be elaborated herein.

Furthermore, the second light-transmitting component is not limited to right-angle prisms; it can be an isosceles triangle, an isosceles trapezoid, or other prism structures. Provided that such structures allow the first light-transmitting component and the second light-transmitting component to be bonded together to form a PBS flat plate structure and ensure both the optical imaging application effect and the passage of S-polarized ultraviolet light through the designated region, they are therefore all applicable and will not be elaborated herein.

It needs to be noted that optical contacting relies on the molecular attraction between [0035] the polished surfaces of parts to combine light-transmitting components into complex optical assemblies, such that rhombic prisms and right-angle prisms can be bonded together through optical contacting at room temperature, avoiding the absorption loss of photo-alignment ultraviolet light by adhesives. Furthermore, the inclined surfaces of both the rhombic prisms and right-angle prisms have a higher degree of surface flatness.

Furthermore, the polarizing beam splitter array utilizes molecular attraction to achieve bonding between two adjacent prisms without the use of any bonding agent. During bonding, pressure is applied to two prisms, causing the two clean, smooth, and identically shaped optical prism surfaces to bond together. The friction of the smoother prism contact surface is reduced within a certain range, but when the smoothness exceeds a certain limit, the friction increases.

The principle of optical contacting refers to that the molecules on the surfaces of two objects are tightly adjacent to each other, with a very small distance between them, and due to the electromagnetic forces between the molecules, they attract each other; the smoother the surface of the objects, the smaller the distance between the molecules, and the greater the attractive force; therefore, separating the two objects becomes very difficult. In this embodiment, the two objects are a first light-transmitting component and a second light-transmitting component; the first light-transmitting component and the second light-transmitting component can form a single piece without a distinct internal interface through optical contacting.

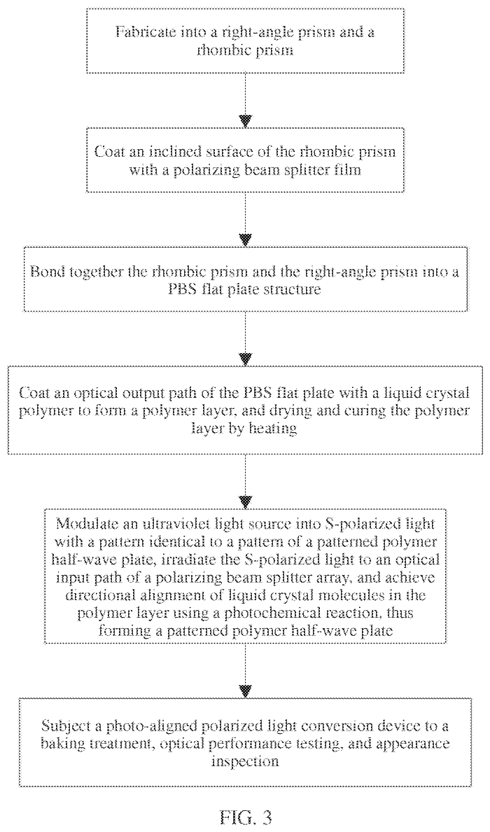

Also provided in this embodiment is a manufacturing method for a polarized light conversion device, which utilizes the aforementioned polarized light conversion device. Referring to FIG. 3, the manufacturing method for a polarized light conversion device includes the following steps:
step S1, polarizing beam splitter (PBS) fabrication: selecting a quartz glass material as a substrate material for a prism, and fabricating same into a right-angle prism and a rhombic prism.

Preferably, a quartz glass material capable of transmitting both far-ultraviolet light and visible and near-infrared light is selected as the substrate material for the prism, and the substrate material is fabricated into the right-angle prism and the rhombic prism; the right-angle prism has a specification of 2*2 mm, and the specifications of the rhombic prism are a width of 2 mm and an inclination angle of 45 degrees.
step S2, PBS film coating: coating an inclined surface of the rhombic prism with a polarizing beam splitter film.

Long inclined surfaces of two sides of the rhombic prism are coated with a polarizing beam splitter film, ensuring both the optical imaging application effect and the passage of S-polarized ultraviolet light through the designated region.

Furthermore, the specifications of the polarizing beam splitter film (PBS film) are as follows: Tp>99%@420-680 nm; Rs>99%@350-680 nm; AOI=45 degrees (incident on glass).
step S3, PBS flat plate fabrication: bonding together inclined surfaces of two adjacent rhombic prisms through a bonding material, and forming a polarizing beam splitter array; connecting both ends of the polarizing beam splitter array to right-angle prisms through enhanced optical contacting, to form a PBS flat plate structure.

Several rhombic prisms are bonded between two right-angle prisms, long inclined surfaces of two adjacent rhombic prisms are bonded together through optical contacting, and long inclined surfaces of the rhombic prisms are bonded to inclined surfaces of the right-angle prisms through optical contacting; several rhombic prisms and the two right-angle prisms are bonded together into a whole through optical contacting, and the PBS flat plate structure is formed.

It needs to be noted that optical contacting relies on the molecular attraction between the polished surfaces of parts to combine light-transmitting components into complex optical assemblies, such that rhombic prisms and right-angle prisms can be bonded together through enhanced optical contacting at room temperature, avoiding the absorption loss of photo-alignment ultraviolet light by adhesives.

The inclined surfaces of both the rhombic prisms and right-angle prisms have a higher degree of surface flatness.
step S4, polymer coating and curing: coating an optical output path of a PBS flat plate with a liquid crystal polymer to form a patterned polymer layer, and drying and curing the polymer layer by heating.

The curing temperature for the polymer layer is 80° C.-110° C., and the curing duration is 1-2 hours; the thickness of the polymer layer is 100-600 nm.

In this embodiment, in this solution, preferably, the PBS flat plate is coated with a polymer using a spin-coating method, and after coating, the polarized light conversion device is baked through a hot plate at 100° C. for 1 hour, such that the polymer is dried and cured to form a polymer layer with a thickness of 400 nm.

Furthermore, the PBS flat plate can be coated with liquid crystal polymers using methods such as spin coating, spray coating, ink jet, and screen printing. Provided that such methods can achieve the same effect, they are therefore all applicable and will not be elaborated herein.
step S5, photo-alignment: modulating an ultraviolet light source into S-polarized light with a pattern identical to a pattern of a patterned polymer layer, irradiating the S-polarized light to an optical input path of the polarizing beam splitter array, and achieving directional alignment of liquid crystal molecules in the polymer layer using a photochemical reaction, thus forming the polymer half-wave plate.

Referring to FIG. 2, an ultraviolet light source is modulated into linearly polarized light, and the linearly polarized light is modulated into S-polarized light with a pattern identical to the pattern of the patterned polymer layer through a cylindrical lens array; the S-polarized light is irradiated to an optical input path of the polarizing beam splitter array, and directional alignment of liquid crystal molecules in the polymer layer is achieved using a photochemical reaction, thus forming a patterned polymer half-wave plate.

Furthermore, the ultraviolet light source is ultraviolet light with a wavelength of 330-400 nm.

In this embodiment, an ultraviolet light source with a wavelength of 365 nm is used and modulated into S-polarized light by a polarizer, the linearly polarized light is then modulated into S-polarized light with a pattern identical to the pattern of the patterned polymer layer through a cylindrical lens array, and the S-polarized light is irradiated to an optical input path of the polarizing beam splitter array. Referring to FIG. 2, the S-polarized light passes through the PBS flat plate and irradiates the liquid crystal polymer layer, and a photo-radiated portion of the liquid crystal polymer layer undergoes photo-alignment; anisotropy is generated using a photochemical reaction, that is, photosensitive groups parallel to the polarization direction of the polarized light undergo a photochemical reaction, resulting in anisotropy and achieving the directional alignment of liquid crystal molecules, thus forming a patterned polymer half-wave plate.

Photo-alignment technology utilizes the irradiation of polarized light to change the microscopic alignment direction of liquid crystal molecules; specifically, when polarized light irradiates a liquid crystal material, the energy of photons changes the alignment state of the liquid crystal molecules, causing them to realign along the polarization direction of light. Photo-alignment technology is a method for achieving liquid crystal alignment through irradiation of polarized light, causing the liquid crystals to align regularly at the microscopic level, thus exhibiting macroscopic optical anisotropy.

It needs to be noted that ultraviolet light sources can generally include high-pressure mercury lamps, xenon lamps, halogen lamps, etc., and then monochromatic polarized light is obtained through filtering devices and polarizing devices. A polarized ultraviolet laser or a combination of a non-polarized ultraviolet laser and a polarizer can also be used. Provided that such light sources can achieve the same effect, they are therefore all applicable and will not be elaborated herein.
step S6, post-processing: subjecting a photo-aligned polarized light conversion device to a baking treatment, and subjecting a baked polarized light conversion device to optical performance testing and appearance inspection.

A photo-aligned polymer wave plate is placed in an oven for a baking treatment to facilitate the reaction of the polymer functional groups, further stabilize the alignment, and eliminate the stress that may be generated during photo-alignment, thereby achieving a more ideal photo-alignment effect and enabling the wave plate to reach the expected optical retardation performance.

The baking temperature is 90° C.-130° C., and the baking duration is 1-10 minutes.

In this embodiment, a photo-aligned polarized light conversion device is placed in an oven for a baking treatment at 110° C. for 5 minutes. Afterward, the polarized light conversion device is subjected to relevant optical performance testing and appearance inspection using relevant optical testing equipment, ensuring that the polarized light conversion device meets the design requirements.

In the present disclosure, this refers to a technique in which through the irradiation with laser or polarized ultraviolet light, photo-polymerization, photo-isomerization, or photo-decomposition reactions are induced in the polymer layer on the substrate, thereby generating surface anisotropy to induce the alignment of liquid crystal molecules. In the photo-alignment process, when a photosensitive liquid crystal polymer material is irradiated with polarized ultraviolet light, a photochemical reaction will occur on its surface, leading to changes in the material's surface properties and the generation of anisotropy. This anisotropy, in turn, induces the liquid crystal molecules to align along a specific direction, achieving the orientation of the liquid crystal wave plate. By precisely controlling the polarization direction and irradiation region of light, surface pattern structures can be obtained on the polymer surface, causing the liquid crystal molecules in different regions to maintain the same orientation. This is highly advantageous for fabricating patterned liquid crystal polymer wave plates.

Therefore, this technical solution can be used for half-wave plates of PBS flat plates, providing optical applications with phase delay; moreover, the polarized light path of the PBS flat plates can be utilized to achieve localized exposure, thereby forming a patterned wave plate structure. In this way, the fabrication process of the PBS flat plates can be significantly simplified. The PBS film is designed to reflect specified linearly polarized ultraviolet light, ensuring exposure in a designated region to form a patterned wave plate structure.

In summary, in the present disclosure, through the improvement in the connection method between the half-wave plate and the polarizing beam splitter in the polarized light conversion device, the problems in the prior art where the relative precision of the polarizing beam splitter and the half-wave plate during manufacturing leads to fabrication difficulties and consequently affects the reliability of the polarized light converter and light source, can be effectively mitigated. Meanwhile, the precise bonding steps between the wave plate and the PBS array are simplified, achieving direct formation, simplifying the process, and reducing costs; problems such as wave plate misalignment and air bubbles caused when many long wave plate strips are precisely positioned and bonded to the designated region of the PBS array are avoided.

According to the present disclosure, the PBS optical path is utilized to directly fabricate a patterned half-wave plate in a required region on the liquid crystal polymer layer, replacing the traditional wave plate bonding process, and greatly reducing the fabrication difficulty; the present disclosure can be applied to various precise and miniaturized practical application scenarios, achieving the miniaturization or micro-miniaturization of optical systems. The fabrication method of the present disclosure features miniaturization, ease of integration, and a thin and lightweight design, and has great application potential in fields such as displays and optical communications.

The above embodiments are only used to illustrate the technical solutions of the present disclosure, and are not intended to limit it. Although the present disclosure has been described in detail with reference to the foregoing embodiments, those of ordinary skill in the art should understand that: the technical solutions described in the foregoing embodiments can still be modified, or some of the technical features can be equivalently replaced; and these modifications or substitutions do not cause the essence of the corresponding technical solutions to deviate from the spirit and scope of the technical solutions of the embodiments of the present disclosure.

1. A polarized light conversion device, comprising:
a polarizing beam splitter array, formed by bonding at least two first light-transmitting components, second light-transmitting components being bonded to both ends of the polarizing beam splitter array, and a polarizing beam splitter film being disposed between each of the at least two first light-transmitting components and one of the at least two first light-transmitting components or one of the second light-transmitting components adjacent thereto; and
a half-wave plate, disposed on an optical output path of the polarizing beam splitter array,
wherein the half-wave plate is a patterned polymer layer made of a liquid crystal polymer; and
the patterned polymer layer is formed by achieving directional alignment of liquid crystal molecules in a polymer layer through a photochemical reaction using S-polarized light emitted from the polarizing beam splitter array, enabling a liquid crystal polymer layer to be directly patterned to serve as the half-wave plate.

2. The polarized light conversion device according to claim 1, wherein the at least two first light-transmitting components are rhombic prisms, and the second light-transmitting components are right-angle prisms; at least two of the rhombic prisms are arranged between the right-angle prisms, and each prism connection is coated with the polarizing beam splitter film.

3. The polarized light conversion device according to claim 2, wherein each of the rhombic prisms and one of the rhombic prisms or one of the right-angle prisms adjacent thereto are bonded together into a whole through optical contacting.

4. The polarized light conversion device according to claim 1, wherein the S-polarized light is modulated by an ultraviolet light source, and a pattern thereof is completely identical to a pattern of the patterned polymer layer.

5. A polarized light conversion device, comprising:
a polarizing beam splitter array, formed by bonding at least two first light-transmitting components, second light-transmitting components being bonded to both ends of the polarizing beam splitter array, and a polarizing beam splitter film being disposed between each of the at least two first light-transmitting components and one of the at least two first light-transmitting components or one of the second light-transmitting components adjacent thereto; and
a half-wave plate, disposed on an optical output path of the polarizing beam splitter array,
wherein the half-wave plate is a polymer layer formed by coating a liquid crystal polymer on the optical output path of the polarizing beam splitter array and patterning the liquid crystal polymer by directly using S-polarized light emitted from the polarizing beam splitter array during manufacturing.

6. The polarized light conversion device according to claim 5, wherein the at least two first light-transmitting components are rhombic prisms, and the second light-transmitting components are right-angle prisms; at least two of the rhombic prisms are arranged between the right-angle prisms, and each prism connection is coated with the polarizing beam splitter film.

7. The polarized light conversion device according to claim 6, wherein each of the rhombic prisms and one of the rhombic prisms or one of the right-angle prisms adjacent thereto are bonded together into a whole through optical contacting.

8. The polarized light conversion device according to claim 5, wherein the S-polarized light is modulated by an ultraviolet light source, and a pattern thereof is completely identical to a pattern of the polymer layer.

9. A manufacturing method for a polarized light conversion device, comprising the following steps:
step S1, fabricating a polarizing beam splitter (PBS) by selecting quartz glass as a substrate material for a prism, and fabricating the quartz glass into a right-angle prism and a rhombic prism;
step S2, coating a PBS film by coating an inclined surface of the rhombic prism with the PBS film;
step S3, fabricating a PBS flat plate by bonding together inclined surfaces of two adjacent rhombic prisms through optical contacting; bonding together at least two rhombic prisms into a whole through the optical contacting, to form a PBS array; and bonding right-angle prisms to both ends of the PBS array through the optical contacting, to form the PBS flat plate;
step S4, coating a polymer and curing by coating an optical output path of the PBS flat plate with a liquid crystal polymer to form a polymer layer, and drying and curing the polymer layer by heating;
step S5, photo-aligning by modulating an ultraviolet light source into S-polarized light with a pattern identical to a pattern of a patterned polymer half-wave plate, irradiating the S-polarized light to an optical input path of the PBS array, and achieving directional alignment of liquid crystal molecules in the polymer layer using a photochemical reaction, thus forming the patterned polymer half-wave plate; and
step S6, post-processing by subjecting a photo-aligned polarized light conversion device to a baking treatment, and subjecting a baked polarized light conversion device to optical performance testing and appearance inspection.

10. The manufacturing method for a polarized light conversion device according to claim 9, wherein specific steps of the step S1 are as follows:
selecting the quartz glass, wherein selecting the quartz glass comprises selecting quartz glass capable of transmitting both far-ultraviolet light and visible and near-infrared light as the substrate material for the prism, and fabricating the substrate material into the right-angle prism and the rhombic prism.

11. The manufacturing method for a polarized light conversion device according to claim 9, wherein coating the inclined surface in the step S2 comprises: coating a long inclined surface of the rhombic prism with the PBS film,
wherein the PBS film has the following properties: Tp>99%@420-680 nm; Rs>99%@350-680 nm.

12. The manufacturing method for a polarized light conversion device according to claim 9, wherein specific steps of the step S3 are as follows:
bonding the at least two rhombic prisms between two right-angle prisms, wherein long inclined surfaces of the two adjacent rhombic prisms are bonded together through the optical contacting, and long inclined surfaces of the at least two rhombic prisms are bonded to inclined surfaces of the right-angle prisms through the optical contacting; additional rhombic prisms and the two right-angle prisms are bonded together into a whole through the optical contacting, and the PBS flat plate is formed.

13. The manufacturing method for a polarized light conversion device according to claim 9, wherein specific steps of the step S4 are as follows:
coating the optical output path of the PBS flat plate with the liquid crystal polymer to form the polymer layer with a thickness of 100-600 nm, and the polymer layer is dried and cured by heating,
wherein a curing temperature for the polymer layer is 80° C.-110° C., and a curing duration is 1-2 hours.

14. The manufacturing method for a polarized light conversion device according to claim 9, wherein specific steps of the step S5 are as follows:
modulating the ultraviolet light source into linearly polarized light, wherein the linearly polarized light is modulated into the S-polarized light with the pattern identical to the pattern of the patterned polymer half-wave plate through a cylindrical lens array; the S-polarized light is irradiated to the optical input path of the PBS array, the S-polarized light passes through the PBS flat plate and irradiates the polymer layer, and a photo-radiated portion of the polymer layer undergoes photo-alignment; the directional alignment of the liquid crystal molecules in the polymer layer is achieved using the photochemical reaction, and the patterned polymer half-wave plate is formed,
wherein the ultraviolet light source is ultraviolet light with a wavelength of 330-400 nm.

15. The manufacturing method for a polarized light conversion device according to claim 9, wherein in the step S6, a baking temperature is 90° C.-130° C., and a baking duration is 1-10 minutes.
